(19) United States
(12) Patent Application Publication
(10) Pub. No.: US 2014/0215907 A1
(43) Pub. Date: Aug. 7, 2014

(54) STEAM CONCENTRATION CONDUIT, NOZZLE AND WEED KILLING APPARATUS

(71) Applicant: MS GREGSON, Drummondville (CA)

(72) Inventors: Mamadou Diallo, Drummondville (CA); Mario Vitali, Drummondville (CA); Guy Martel, St-Lucien (CA)

(73) Assignee: MS GREGSON, Drummondville (CA)

(21) Appl. No.: 13/757,012

(22) Filed: Feb. 1, 2013

(51) Int. Cl. A01M 21/04; B05B 1/26

(52) U.S. Cl. CPC A01M 21/04; B05B 1/262
USPC 47/1.5; 239/590.3; 239/590.5

(57) ABSTRACT

The present relates to a steam concentration conduit, a steam concentration nozzle and weed killing apparatus for expanding and directing a flow of steam from a steam apparatus, into a concentrated flow of steam. The steam concentration conduit comprises a body having a first end and a second end. The first end is adapted for receiving the flow of steam from the steam apparatus. The body defines between the first end and the second end, a conduit for expanding and directing the flow of steam received at the first end into a concentrated flow of steam.

### TECHNICAL FIELD

The present disclosure relates to a steam concentration conduit, steam concentration nozzle and weed killing apparatus, and more particularly to a conduit, nozzle and apparatus for expanding and directing a flow of steam.

### BACKGROUND

The usage of nozzles is well known in the art of individual and professional steam cleaning apparatuses. Nozzles with particular shapes are affixed to an outlet of steam of the steam cleaning apparatus, to generate a water flow or steam flow suitable for performing a specific cleaning task.

With the restrictions and health issues arising from herbicides, weed killing by steam is slowly growing in popularity. However, efficiency of existing steam weed killing apparatuses needs to be improved so as to become a viable solution for weed killing tasks of various scales. The efficiency of a steam weed killing apparatus depends on its capacity to maintain a directed flow of steam of sufficient pressure and temperature over a reasonable superficies. The efficiency and security also depend on a capacity of maintaining a sufficient temperature at a distance from the steam releasing end of the steam weed killing apparatus. Existing steam weed killing apparatuses and nozzles lack the capability to provide a flow of steam with the aforementioned properties, for the purpose of providing an efficient and safe apparatus for killing weeds.

There is therefore a need for a steam weed killing apparatus and nozzle for generating a steam flow with a substantially constant temperature.

### SUMMARY

In a first aspect, the present disclosure relates to a steam concentration conduit for expanding and directing a flow of steam. The steam concentration conduit comprises a body having a first end for engaging a steam output nozzle of a steam apparatus. The body defines between the first end and a second end a concentration conduit for expanding and directing the flow of steam received from the steam output nozzle into a concentrated flow of steam released at the second end of the body.

In another aspect, the present disclosure relates to a steam concentration nozzle for expanding and directing a flow of steam. The steam concentration nozzle comprises a body having a first end for engaging a steam output of a steam apparatus, the first end defining a steam output nozzle for expelling the flow of steam into the body, the body defining between the first end and a second end a concentration conduit for expanding and directing the flow of steam into a concentrated flow of steam released at the second end of the body.

In yet another aspect, the present relates to a weed killing apparatus for generating a concentrated flow of steam. The weed killing apparatus comprises a steam generator for generating a flow of steam, a steam output nozzle for accelerating and expelling the flow of steam from the steam apparatus, and a steam concentration conduit. The steam concentration conduit has a first end for receiving the flow of steam from the steam output nozzle. The steam concentration conduit defines between the first end and a second end a concentration conduit for expanding and directing the flow of steam into a concentrated flow of steam released at the second end of the steam concentration conduit.

The foregoing and other features of the present steam concentration conduit, steam concentration nozzle and weed killing apparatus will become more apparent upon reading of the following non-restrictive description of examples of implementation thereof, given by way of illustration only with reference to the accompanying drawings.

### BRIEF DESCRIPTION OF THE DRAWINGS

In the appended drawings:

FIG. 1 illustrates a steam concentration conduit for expanding and directing a flow of steam received from a nozzle (not shown) into a concentrated flow a steam, according to a non-restrictive illustrative embodiment;

FIG. 2 illustrates a frontal view and a sectional view of the steam concentration conduit of FIG. 1, according to a non-restrictive illustrative embodiment;

FIG. 3 illustrates a steam concentration conduit with a nozzle, depicting the areas where the flow of steam is expelled along the interior of the steam concentration conduit; and

FIG. 4 is an exemplary temperature profile of the concentrated flow of steam exiting the steam concentration conduit of FIGS. 1-3, according to a non-restrictive illustrative embodiment.

### DETAILED DESCRIPTION

The present disclosure relates to a steam concentration conduit, a steam concentration nozzle and a weed killing apparatus for generating a concentrated flow of steam.

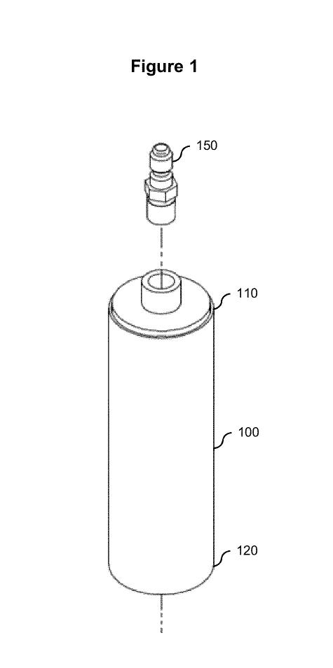

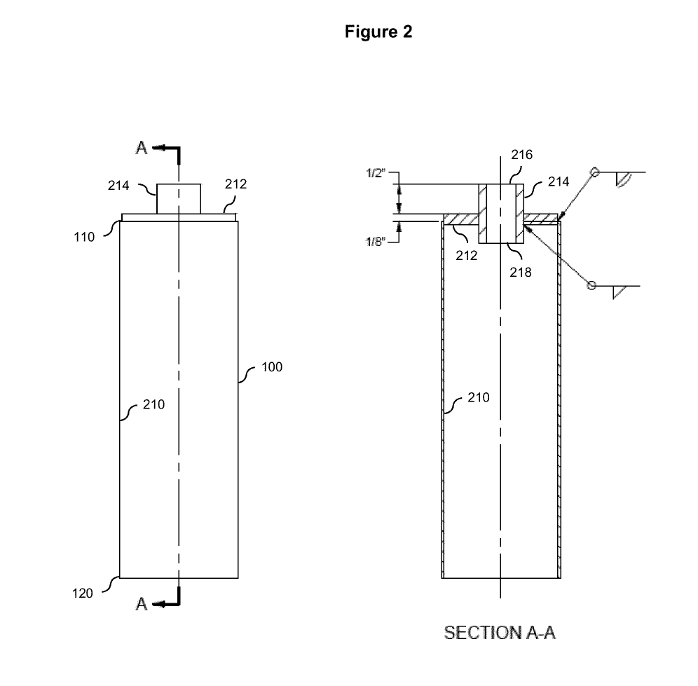

Reference is now made to FIGS. 1 and 2 concurrently, which illustrate the aforementioned steam concentration conduit.

The steam concentration conduit comprises a body having a first end for engaging a nozzle of a steam apparatus, and a second end for releasing the concentrated flow of steam. Alternatively, the steam concentration conduit could include the nozzle, and a connector for engaging the steam apparatus. The body defines, between the first end and the second end, a conduit for transforming a flow of steam received from the nozzle into the concentrated flow of steam.

Thus, FIG. 1 represents a steam concentration conduit comprising the body 100, the first end 110 for receiving a nozzle of a steam apparatus (not shown), or alternatively including the nozzle but comprising a connector for engaging the steam apparatus. The body 100 further comprises the second end 120 for releasing the concentrated flow of steam. Although the body 100 exterior is shown as a cylinder, the present steam concentration conduit is not limited to such a shape or proportions. In fact, the body 100 exterior shape may be round, cylindrical, square, rectangular, polygonal, of smooth or rugged surface. Furthermore, the body 100 may define a series of indentations to facilitate gripping the steam concentration conduit by a user so as to direct the concentrated flow of steam. The exterior of the body 100 may further be made of any material such as for example metal, stainless steel, polymers, rubber, etc. The exterior of the body 100 could further be provided with a protective sleeve, to avoid heat transfer or burning from the flow of steam being concentrated and directed within the body and the exterior of the body.

The first end 110 may be adapted to receive a nozzle of a steam apparatus, of may include the nozzle but alternatively include a connector for connecting the nozzle to the steam apparatus. A male coupler 150 is represented in FIG. 1. The male coupler 150 illustrates an exemplary embodiment of a mechanism for engaging the steam concentration conduit via its first end 110 to the steam apparatus.

FIG. 2 further represents a concentration conduit 210 defined within the body 100 between the first end 110 and the second end 120. The concentration conduit 210 is shaped and sized so as to receive the flow of steam, concentrate and direct the flow of steam into the concentrated flow of steam. As can be appreciated by those skilled in the art, the dimensions of the concentration conduit are designed such as to accommodate operating parameters of the steam apparatus and nozzle, such as for example: pressure of the flow of steam generated by the steam apparatus, temperature of the steam generated by the steam apparatus, desired circumference area of the concentrated flow of steam, heat transfer index of the material used for the concentration conduit 210, etc. Although FIG. 2 shows a cylindrical concentration conduit 210 of the same length as the exterior of the body 100, the present concentration conduit is not limited to such an implementation. In fact, the exterior of the body 100 could be longer, shorter, or equal in length as the concentration conduit 210.

The concentration conduit 210 can thus have different lengths, shapes and proportions, depending on specifications of the steam apparatus, the flow of steam produced by the steam apparatus, the area to be covered by the steam concentration conduit 100, etc. In a particular implementation realized, the concentration conduit 210 had a diameter of two inches and a length of at least 5 inches. In another particular embodiment, the concentration conduit 210 had a length between 6 and 8 inches.

The concentration conduit 210 may be made of any material and shape suitable to receive, concentrate and direct the flow of steam. For example, in a particular embodiment, the concentration conduit 210 may be made of stainless steel. Alternatively, the concentration conduit 210 may further be made of any material such as for example metal, stainless steel, polymers, rubber, etc. Depending on preferences, the steam concentration conduit can be offered separately with an input 214 for receiving a nozzle of the steam apparatus, or the nozzle could be part of the steam concentration conduit, alternative which is hereinafter referred as a steam concentration nozzle.

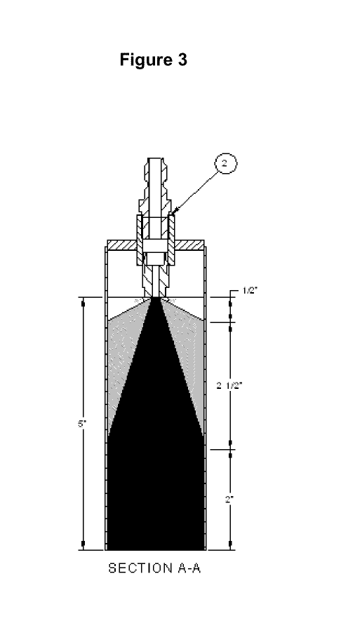

Reference is now made to FIG. 3, which depicts a steam concentration conduit with a steam output nozzle in operation. The expression “steam concentration nozzle” refers to the steam concentration conduit 210 into which is inserted a steam output nozzle. The steam output nozzle may be built within the steam concentration conduit, or may be part of the steam generating apparatus and inserted and temporarily fixed in position within the steam concentration conduit. The steam output nozzle expels the flow of steam into the concentration conduit of the body. The steam output nozzle expels the flow of steam in a circle of diameter larger than the area defined by the concentration conduit. The expelled flow of steam hits the interior wall of the steam concentration conduit, which results in larger droplets (diameter of about 2 mm or more) of steam being created along a periphery of the steam concentration conduit, with the size of the steam droplets reducing towards a center of the concentration conduit (less than 2 mm in diameter). Thus the concentration conduit acts as an expansion chamber for the flow of steam being expelled from the nozzle, while concentrating and directing the flow of steam into a concentrated flow of steam expelled at the second end of the concentration conduit.

The steam concentration conduit of the present disclosure provides several benefits over known nozzles, and is especially interesting for applications such as thermal weed killing. The steam concentration conduit transforms a volatile flow of steam into a concentrated and directed flow of steam which may be used safely, directed with precision over an area to be applied.

Another benefit of the present steam concentration conduit is its capacity to generate a concentrated flow of steam at a substantially constant temperature at the second end of the concentration conduit. Furthermore, as was demonstrated during testing, the formation of the larger steam drops at the periphery of the concentrated flow of steam provides better thermal capacity and allows the concentrated flow of steam to maintain a relatively constant temperature over the area of the concentrated flow of steam, even at a distance from the second end of the concentration conduit.

Another benefit of the present steam concentration conduit is to provide an accrued security by better preventing undesired splashes and/or bursts of steam for a user or anyone in proximity of the steam concentration conduit during operation of the weed killing apparatus.

Because of its inherent simplicity, the present steam concentration conduit is light, durable, economical to produce, efficient, safe and pleasant to use.

The aforementioned benefits result from the redirection and concentration of the flow of steam expelled by the steam output nozzle by the steam concentration conduit.

The particular shape and dimensions of the steam concentration conduit are such that the concentrated flow of steam flow released by the steam concentration conduit (at its output) has the highest temperature possible, and that the concentrated flow of steam cools as little as possible by forming a concentrated flow of steam with larger steam droplets along a periphery of the concentrated flow of steam. The goal of thermal weeding being to kill the vegetation, higher temperature of the concentrated flow of steam flow temperature at a certain distance from the end of the steam concentration conduit, the better results are obtained for killing undesired weeds.

In addition, the concentrated flow of steam undergoes little deformation after exiting the steam concentration conduit. Thus, it is easier for the user to see if the vegetation has been hit, and consequently treated. And as the temperature of the concentrated flow of steam is maintained over its entire cross-section, there are no areas within the concentrated flow of steam where the steam drops are not effective. Thus, vegetation hit by the coverage of the concentrated flow of steam is treated uniformly.

FIG. 2 illustrates a particular embodiment of the steam concentration conduit with a cylindrical ring 212 and a connection cylinder 214. The cylindrical ring 212 is engaged in the cylindrical conduit 210. And the connection cylinder 214 is engaged in an aperture in the center of the cylindrical ring 212. Further, the connection cylinder 214 has an inlet end 216 for receiving the nozzle of the steam apparatus (not represented in FIG. 2), and an outlet end 218 for outputting the nozzle in the concentration conduit and thereby expel the flow of steam received from the steam apparatus in the concentration conduit 210. In an exemplary embodiment, the connection cylinder 214 may engage (via its inlet end 216) a male coupler 150 (as represented in FIG. 1) attached to the steam apparatus. The steam received from the steam apparatus flows through the male coupler 150, and then the connection cylinder 214, to finally reach the nozzle located in the cylindrical conduit 210.

In a particular aspect of the steam concentration conduit, the substantially constant temperature is maintained at a distance of at least 18 inches from the outlet end of the steam concentration conduit. In a particular aspect of the steam concentration conduit, the substantially constant temperature is at least 175° F. A temperature of 175° F. is the minimal temperature required for killing weeds.

Following is an exemplary table of experimentation results realized for a specific steam apparatus, to determine the length of a cylindrical steam concentration conduit with a diameter of two inches, to obtain a temperature of at least 175° F. at distances of 1 inch, 3 inches, and 6 inches from the releasing end (the second end) of the steam concentration conduit. The diameter of the steam concentration conduit has been set at 2 inches, by means of experimentation based on the nozzle that was available (not represented in the table). Results with a conical steam concentration conduit are also provided for comparison purposes. The results show that only a cylindrical steam concentration conduit of diameter 2 inches, with a length of 6 or 8 inches, maintains the target of 175° F. for the aforementioned distances.

| Steam | Form of the | Temperature | | Temperature | | Temperature | |
|---|---|---|---|---|---|---|---|
| concentration | Concentrated | at 1 inch (° F.) | | at 3 inches (° F.) | | at 6 inches (° F.) | |
| conduit | steam flow | Center | Periphery | Center | Periphery | Center | Periphery |
| Conical | Conical, | 210 | 150 | 210 | 120 | 203 | 110 |
| | smaller droplets | | | | | | |
| Cylindrical, | Cylindrical, | 213 | 195 | 212 | 193 | 212 | 190 |
| 8 po | larger drops | | | | | | |
| Cylindrical, | Cylindrical, | 213 | 195 | 212 | 193 | 212 | 190 |
| 6 po | larger drops | | | | | | |
| Cylindrical, | Cylindrical, | 213 | 190 | 212 | 181 | 212 | 160 |
| 4 po | smaller drops | | | | | | |
| Cylindrical, | Conical | 210 | 155 | 210 | 130 | 205 | 115 |
| 2 po | smaller droplets | | | | | | |

With the cylindrical steam concentration conduit, the concentrated flow of steam remains cylindrical up to 18 inches from the releasing end (the second end) of the cylindrical steam concentration conduit. For illustration purposes, a temperature of the flow of steam expelled by the nozzle of substantially 250° F. was used. The temperature at a periphery of the concentrated flow of steam remained constant at 190° F., at a distance of 6 inches to 18 inches from the end of the cylindrical steam concentration conduit. The temperature at a center of the concentrated flow of steam decreased from 213° F. to 200° F., at a distance of 1 inch (213° F.) to 18 inches (200° F.) from the releasing end of the cylindrical steam concentration conduit. There is thus heat diffusion from the center of the concentrated flow of steam towards its periphery. Moreover, the fact that the concentrated flow of steam remains cylindrical allows for a lower loss of heat. This property of the concentrated flow of steam will be further discussed.

The shape and length of the steam concentration conduit are such that smaller steam droplets expelled by the nozzle are grouped on the wall of the steam concentration conduit to form larger steam drops. The larger steam drops have a sufficient size for not dispersing in any direction, and further for keeping their warmth. Indeed, the larger steam drops located at the periphery of the concentrated flow of steam loose a little heat, but at the same time they recover heat from smaller steam droplets at the center of the concentrated flow of steam, allowing the larger steam drops located at the periphery of the concentrated flow of steam to relatively keep their temperature. Therefore, since there is no significant cooling of the concentrated flow of steam, it is not necessary to work at a very short distance from the surface to be treated. Holding the steam concentration conduit at a greater distance from the surface to be treated makes the work easier to perform, and reduces the risk of splashes for the user.

An effect of the propulsion of the larger steam drops is that the smaller steam droplets (the remaining ones which were not grouped into larger steam drops or evaporated) are mostly found at the center of the concentrated flow of steam. Thus, smaller steam droplets are protected against the wind by the larger steam drops; which in turn reduces the risk for the user to be reached by an outburst of steam during windy days.

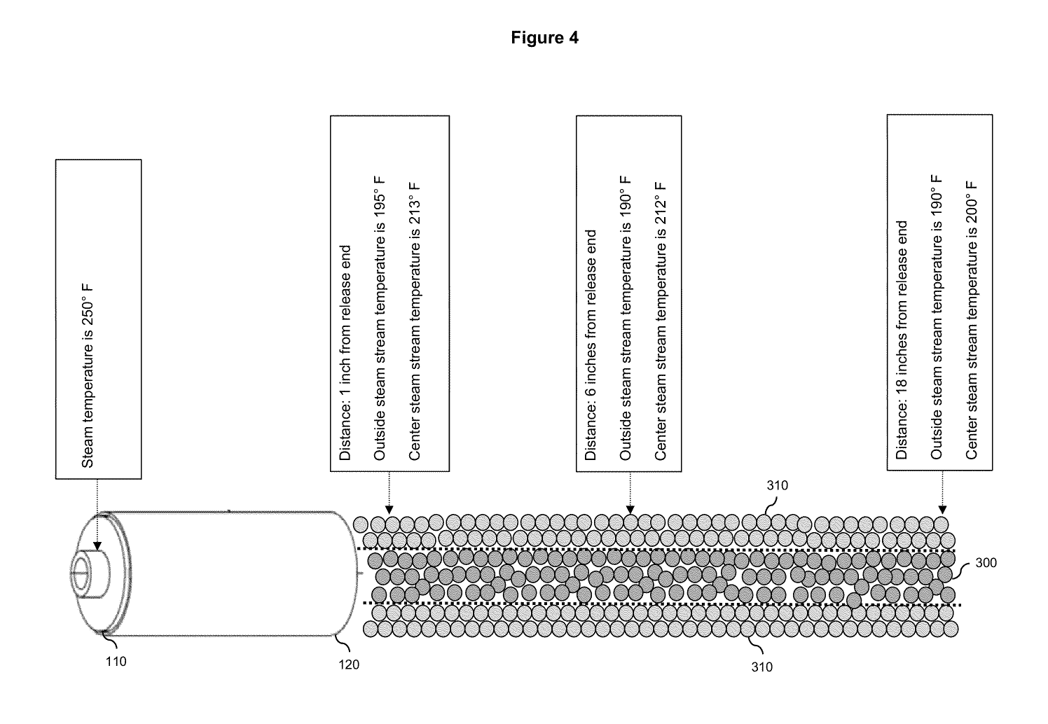

FIG. 4 illustrates a cylindrical concentrated flow of steam with a substantially constant temperature generated by an embodiment of the present steam concentration conduit. The temperatures represented in FIG. 4 are temperatures which were measured with a prototype of the present steam concentration conduit; with a cylindrical steam concentration conduit of diameter of 2 inches and a length of 6 inches. At the first end 110 of the steam concentration conduit, the temperature of the steam received from the nozzle was substantially at 250° F.

At a distance of 1 inch from the second end 120 of the steam concentration conduit, the temperature was substantially 195° F. along the periphery 310 of the concentrated flow of steam and substantially 213° F. at the center 300 of the concentrated flow of steam. At a distance of 6 inches from the second end 120 of the steam concentration conduit, the temperature was substantially 190° F. along the periphery 310 of the concentrated flow of steam and substantially 212° F. at the center 300 of the concentrated flow of steam. At a distance of 18 inches from the second end 120 of the steam concentration conduit, the temperature was substantially at 190° F. along a periphery 310 of the concentrated flow of steam and substantially at 200° F. at the center 300 of the concentrated flow of steam. Thus FIG. 4 illustrates and confirms the property of the concentrated flow of steam exiting the second end 120 of the steam concentration conduit, i.e. the concentrated flow of steam comprises smaller steam droplets, and a periphery section 310 containing larger steam drops.

In a particular embodiment of the steam concentration conduit, the concentrated flow of steam has a pressure of substantially 40 PSI and a flow of substantially 3 Gallons Per Minute.

The present disclosure also relates to a weed killing apparatus for generating a concentrated flow of steam. The weed killing apparatus comprises a steam source with a nozzle for expelling a flow of steam. The weed killing apparatus further comprises a steam concentration conduit as previously discussed for receiving the flow of steam, expanding and directing the flow of steam into the concentrated flow of steam.

Although the present steam concentration conduit, nozzle and weed killing apparatus have been described in the foregoing description by way of illustrative embodiments thereof, these embodiments can be modified at will, within the scope of the appended claims without departing from the spirit and nature of the appended claims.

1. A steam concentration conduit for expanding and directing a flow of steam, the steam concentration conduit comprising:
a body comprising a first end for engaging a steam output nozzle of a steam apparatus, the body defining between the first end and a second end a concentration conduit for expanding and directing the flow of steam received from the steam output nozzle into a concentrated flow of steam released at the second end of the body.

2. The steam concentration conduit of claim 1, wherein the concentration conduit is so proportioned that a concentrated flow of steam at the second end of the concentration conduit consists in larger steam drops near a periphery of the concentration conduit and smaller steam droplets in a center of the concentration conduit.

3. The steam concentration conduit of claim 2, wherein the concentrated flow of steam at the second end has a substantially constant temperature of at least 175° F.

4. The steam concentration conduit of claim 3, wherein the substantially constant temperature is maintained at a distance of at least 18 inches from the second end of the steam concentration conduit.

5. The steam concentration conduit of claim 1, wherein the concentrated flow of steam has a pressure of at least 40 pounds per square inch (PSI) and a flow of at least 3 gallons per minute (GPM).

6. A weed killing apparatus for generating a concentrated flow of steam comprising:
a steam apparatus for generating a flow of steam;
a steam output nozzle for accelerating and expelling the flow of steam from the steam apparatus;
a steam concentration conduit, the steam concentration conduit having a first end for receiving the flow of steam from the steam output nozzle, the steam concentration conduit defining between the first end and a second end a concentration conduit for expanding and directing the flow of steam into a concentrated flow of steam released at the second end of the steam concentration conduit.

7. The weed killing apparatus of claim 6, wherein the concentration conduit is so proportioned that a concentrated flow of steam at the second end of the concentration conduit consists in larger steam drops near a periphery of the concentration conduit and smaller steam droplets in a center of the concentration conduit.

8. The weed killing apparatus of claim 7, wherein the concentrated flow of steam at the second end has a substantially constant temperature of at least 175° F.

9. The weed killing apparatus of claim 8, wherein the substantially constant temperature is maintained at a distance of at least 18 inches from the second end of the steam concentration conduit.

10. The weed killing apparatus of claim 6, wherein the concentrated flow of steam has a pressure of at least 40 pounds per square inch (PSI) and a flow of at least 3 gallons per minute (GPM).

11. A steam concentration nozzle for expanding and directing a flow of steam, the steam concentration nozzle comprising:
a body comprising a first end for engaging a steam output of a steam apparatus, the first end defining a steam output nozzle for expelling the flow of steam into the body, the body defining between the first end and a second end a concentration conduit for expanding and directing the flow of steam into a concentrated flow of steam released at the second end of the body.

12. The steam concentration nozzle of claim 11, wherein the concentration conduit is so proportioned that a concentrated flow of steam at the second end of the concentration conduit consists in larger steam drops near a periphery of the concentration conduit and smaller steam droplets in a center of the concentration conduit.

13. The steam concentration nozzle of claim 12, wherein the concentrated flow of steam at the second end has a substantially constant temperature of at least 175° F.

14. The steam concentration nozzle of claim 13, wherein the substantially constant temperature is maintained at a distance of at least 18 inches from the second end of the steam concentration conduit.

15. The steam concentration nozzle of claim 11, wherein the concentrated flow of steam has a pressure of at least 40 pounds per square inch (PSI) and a flow of at least 3 gallons per minute (GPM).
